(19) United States
(12) Patent Application Publication
(10) Pub. No.: US 2018/0112986 A1
(43) Pub. Date: Apr. 26, 2018

(54) Navigation Device

(71) Applicant: Relish Technologies Limited, London (GB)

(72) Inventors: Thomas Putnam, London (GB); Mark Jenner, London (GB); Charles Bruce, London (GB); Alex Hulme, London (GB); Julie Arrive, London (GB); Jon Marshall, London (GB)

(21) Appl. No.: 15/572,361

(22) PCT Filed: May 6, 2016
(86) PCT No.: PCT/GB2016/051307

§ 371 Date: Nov. 7, 2017

(30) Foreign Application Priority Data
May 7, 2015 (GB) 1507851.2
Oct. 19, 2015 (GB) 1518479.9

(51) Int. Cl. G01C 21/20; G01C 21/10; G01C 21/36; H04W 4/02; G01S 3/14; G01C 17/28; G01C 19/36

(52) U.S. Cl. CPC G01C 21/20; G01C 21/10; G01C 21/3667; G01C 19/36; G01S 3/14; G01C 17/28; H04W 4/025

(57) ABSTRACT

The present invention is directed towards a navigation device (12) for receiving navigation data from a portable computing device (11). The navigation device (12) comprises a display (21) and at least one sensor (22, 23, 24) configured to determine a reference direction, the reference direction being a direction relative to the display (21). The navigation device (12) further comprises wireless communication means (25) for wirelessly receiving data relating to a desired bearing from a portable computing device (11) and a processing unit connected to the display (21), the at least one sensor (22, 23, 24) and the wireless communication means (25). The processing unit is configured to receive a desired bearing from the wireless communication means (25); receive the reference direction from the at least one sensor (22, 23, 24); determine a desired direction based upon the reference direction and desired bearing; and operate the display (21) to display an indicium for indicating the desired direction relative to the display (21). The navigation device (12) is particularly suitable for mounting on bicycles.

The present invention is directed towards a navigation device. The present invention is further directed towards a navigation system, a method of operating a navigation system, a navigation device apparatus and an apparatus.

Navigation devices commonly comprise a device with a location sensor for determining the absolute position of the device and maps stored on a memory or downloaded from the Internet. The location sensor typically determines the position utilising the Global Positioning System (GPS) or the like. The device receives a desired location via an input from a user and, based upon the device position, determines an appropriate route for the user to travel to reach the desired location. The device typically displays the map and route for the user to see. However, the devices typically comprise relatively complex and high power consuming components and therefore have a short battery life and are relatively high cost. Some devices are capable of being continuously powered, for example from a vehicle battery, but power supply arrangements are not suitable on, for example, bicycles or the like.

Bicycle navigation devices need to have an integrated power supply and be relatively small, so are typically standalone battery powered devices or smartphones with suitable applications and hardware installed. However, smartphones suffer from quick battery drainage during continuous use of their hardware and are relatively expensive. Furthermore, the safety of a cyclist using such devices is reduced as their attention is diverted from the local environment for some time when reading the relatively large amount of map and direction data displayed by the device.

An object of the present invention is therefore to provide an effective navigation device with a long battery life. A further object is to provide a navigation device which is simpler for a user to read and thereby improve user safety. Yet a further object is to provide a relatively low cost navigation device.

The present invention therefore provides a navigation device for receiving navigation data from a portable computing device, the navigation device comprising: a display; at least one sensor configured to determine a reference direction, the reference direction being a direction relative to the display; wireless communication means for wirelessly receiving data relating to a desired bearing from a portable computing device; and a processing unit connected to the display, the at least one sensor and the wireless communication means, the processing unit being configured to: receive a desired bearing from the wireless communication means; receive the reference direction from the at least one sensor; determine a desired direction based upon the reference direction and desired bearing; and operate the display to display an indicium for indicating the desired direction relative to the display.

In particular, the desired direction may be calculated as the difference between the reference direction and the desired bearing. The navigation device is preferably for a bicycle. The navigation device preferably does not calculate its absolute position or the desired position and preferably does not contain the hardware and/or computer program instructions for doing so. The navigation device preferably does not comprise a GPS unit, position determination means and/or cellular network communication means. The navigation device is preferably not capable of performing Voice over Internet Protocol (VoIP), Internet telephony or the like. The navigation device is preferably not capable in normal use of wirelessly communicating with a device more than 100 m distant. As a result, the navigation device is a relatively low power consuming and cheap. Furthermore, as it displays the desired direction to a user, rather than step-by-step (i.e. “turn left” or “turn right”) directions, it can be read easily and a user's safety is improved.

Preferably the reference direction is the direction of magnetic north and the desired bearing is an absolute bearing relative to the direction of magnetic north. Preferably the at least one sensor comprises a compass and/or a gyroscope. Preferably the processing unit is configured to receive a compass reference direction and calibrate a gyroscope reference direction based on the compass reference direction. Preferably the processing unit is configured to: receive compass and gyroscope reference directions; determine whether a difference relating to the compass and gyroscope reference directions is greater than a threshold value; and determine a desired bearing based upon the gyroscope reference direction and the desired bearing if the difference is greater than the threshold value; or determine a desired bearing based upon the compass reference direction and the desired bearing if the magnitude is less than the threshold value.

The processing unit may also be configured to: determine compass and gyroscope reference directions; determine a desired direction based upon the gyroscope reference direction; determine a confidence parameter associated with the compass; and, if the confidence parameter meets a threshold value, calibrate the gyroscope to the compass reference direction. The compass may be configured to determine and provides outputs relating to the direction and magnitude of magnetic fields, particularly the magnetic field of the Earth. The confidence parameter may be based upon, for example, the recent rate of change of the magnitude and/or direction output and/or the deviation of the magnitude and/or direction output from a certain value by a threshold magnitude.

The processing unit may also determine that an external magnetic field (i.e. one that is not the magnetic field of the Earth) is present and calculate the compass reference direction taking the external magnetic field into account.

In preferred embodiments the wireless communication means is for receiving map and/or distance data; and the processing unit is configured to receive the map and/or distance data from the wireless communication means and operate the display to show the map and/or distance data.

Preferably the compass is a magnetometer. Preferably the at least one sensor comprises an accelerometer and the processing unit is configured to receive acceleration data from the accelerometer. Preferably the device further comprises at least one input connected to the processing unit, the processing unit being configured to send data to the portable computing device via the wireless communication means.

Preferably the processing unit is configured to determine the reference direction based upon the output of the accelerometer, compass and gyroscope. The present invention further provides a navigation device apparatus comprising the navigation device as claimed in any one of the preceding claims and a mount for mounting the navigation device on a bicycle.

The present invention yet further provides a navigation system comprising the aforementioned navigation device and a portable computing device comprising wireless communication means for wireless communication with the wireless communication means of the navigation device. Preferably the portable computing device comprises: position determination means for determining the absolute position of the portable computing device; at least one input means for receiving an input from a user relating to a desired position; and a further processing unit configured to determine a desired bearing based upon the absolute position and the desired position and send the desired bearing to the navigation device via the wireless communication means.

Preferably the further processing unit and/or navigation system is configured to: determine a travel direction of the portable computing device based upon sequential determinations of the absolute position of the portable computing device; determine a desired bearing as a relative bearing between the travel direction and a desired direction, the desired direction being that from the absolute position and the desired position; and send the desired bearing to the navigation device, wherein the processing unit of the navigation device is configured to: determine a desired direction based upon the desired bearing and a reference direction of travel of the navigation device; and indicate the desired direction on the navigation device.

The present invention yet further provides a method of operating a navigation system comprising a navigation device, the navigation device comprising a display, at least one sensor, wireless communication means and a processing unit, wherein the method comprises: determining a reference direction of the navigation device via the at least one sensor; receiving at the navigation device a desired bearing from a portable computing device via the wireless communication means; operating the processing unit to determine a bearing difference between the desired direction based upon the reference direction and desired bearing; and operating the display to display an indicium, the indicium being oriented relative to the display based upon the desired direction.

In preferred embodiments the at least one sensor comprises a compass and/or a gyroscope and the method comprises: receiving, at the processing unit of the navigation device, compass and gyroscope reference directions; operating the processing unit to: determine whether a difference relating to the compass and gyroscope reference directions is greater than a threshold value; and determine a desired bearing based upon the gyroscope reference direction and the desired bearing if the magnitude is greater than the threshold value; or determine a desired bearing based upon the compass reference direction and the desired bearing if the magnitude is less than the threshold value.

Preferably the system further comprises a portable computing device, the portable computing device comprising wireless communication means, position determination means, at least one input means and a further processing unit, wherein the method further comprises: determining the absolute position of the portable computing device via the position determination means; receiving an input relating to a desired position at the at least one input means; determining, via the further processing unit, a desired bearing based upon the absolute position and the desired position; and sending the desired bearing to the navigation device via the wireless communication means.

Preferably the method further comprises: determining a travel direction of the portable computing device based upon sequential determinations of the absolute position of the portable computing device; determining, via the further processing unit, a desired bearing as a relative bearing between the travel direction and a desired direction, the desired direction being that from the absolute position and the desired position; sending the desired bearing to the navigation device via the wireless communication means; determining, at the processing unit of the navigation device, a desired direction based upon the desired bearing and a reference direction of travel of the navigation device; and indicating the desired direction on the display of the navigation device.

Preferably the method further comprises: calculating, via the further processing unit, a distance between the absolute position and desired position; and/or retrieving, via the further processing unit, from a memory or network map data relating to the absolute position; sending the map and/or distance data to the navigation device via the wireless communication means; and displaying the map and/or distance data on the display of the navigation device.

The present invention yet further provides a navigation system comprising: a first device arranged to determine a current position of the first device, receive a desired position and calculated a desired bearing; and a second device arranged to calculate a current direction or reference direction of the second device, receive the desired bearing, calculate a desired direction from the desired bearing and current direction or reference direction and display the desired direction. Preferably the first device is enclosed in a first housing separated from a second housing enclosing the second device. Preferably the second device does not comprise absolute position sensing means.

The present invention yet further provides a navigation device apparatus for a bicycle comprising: an electronic navigation device comprising a display; a mount for receiving the electronic navigation device in a storage orientation, in which the display is covered by the mount, and in a display orientation, in which the mount supports the electronic navigation device such that the display is readable by a user; and a substantially elastic strap connected to the electronic navigation device and mount and arranged for wrapping around a bicycle component to fix the mount and electronic navigation device in the in-use orientation to the bicycle component.

The present invention yet further provides an apparatus comprising a bicycle and the aforementioned device, system and/or or apparatus mounted on the bicycle. The present invention further provides a method according to any one of claims 25 to 33.

By way of example only, embodiments of a navigation system, navigation apparatus, navigation device, apparatus and method in accordance with the present invention are now described with reference to, and as shown in, the accompanying drawings, in which:

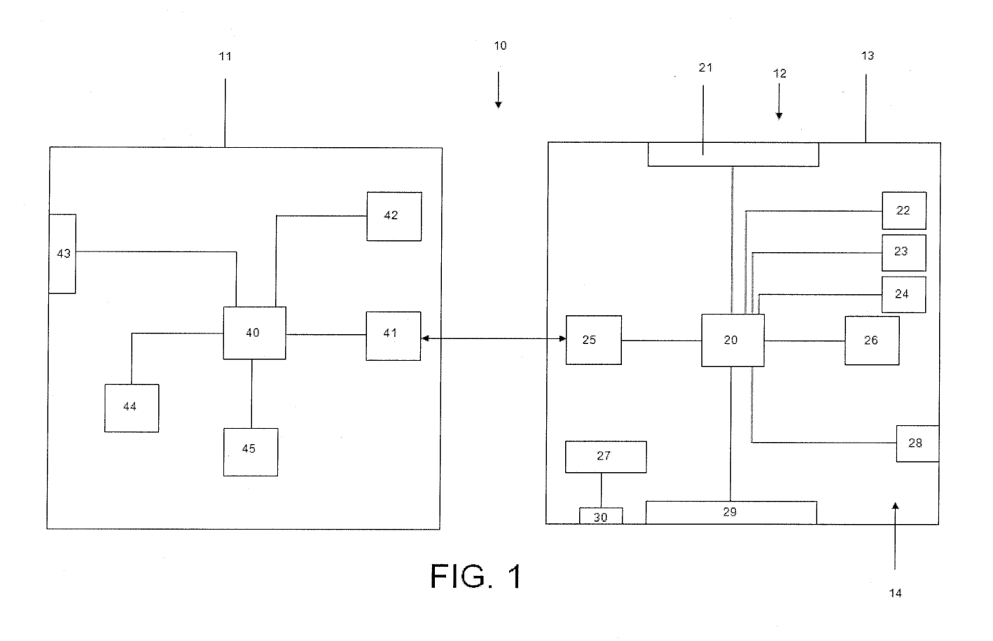

FIG. 1 is a schematic of a navigation system of the present invention;

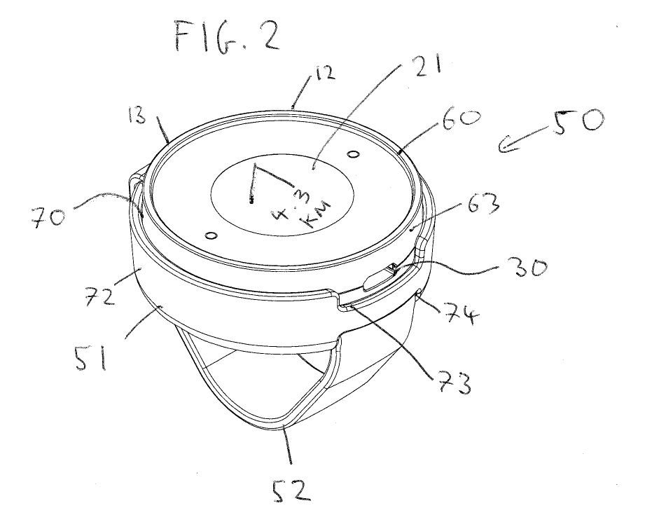

FIG. 2 is a perspective view of a navigation apparatus of the present invention in a display orientation;

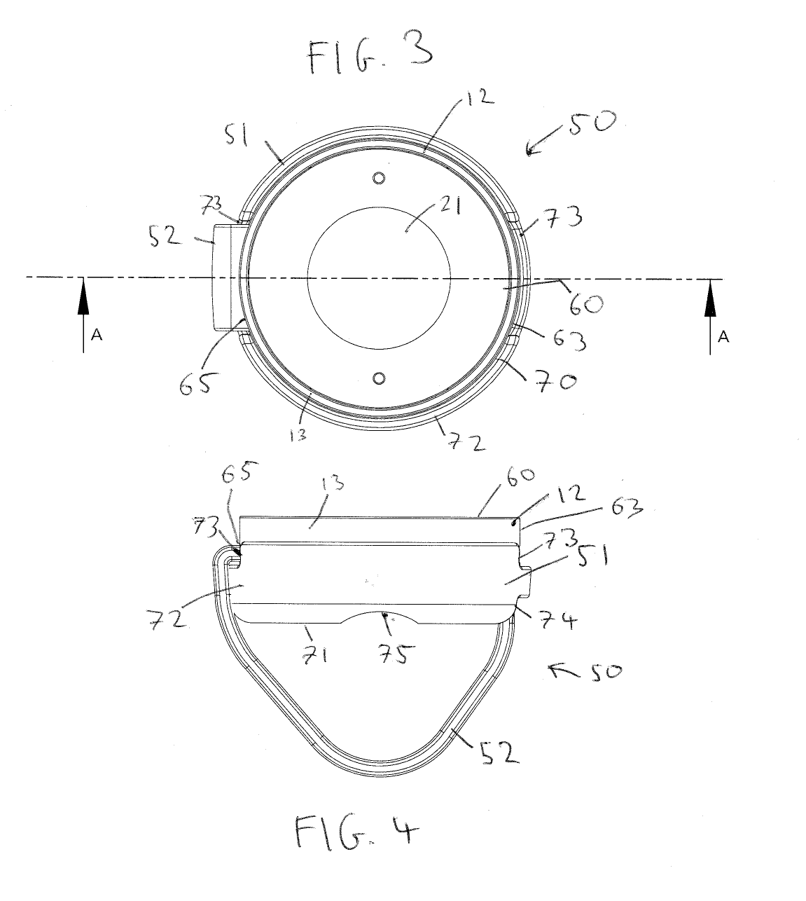

FIG. 3 is a plan view of the navigation apparatus of FIG. 2 in the display orientation;

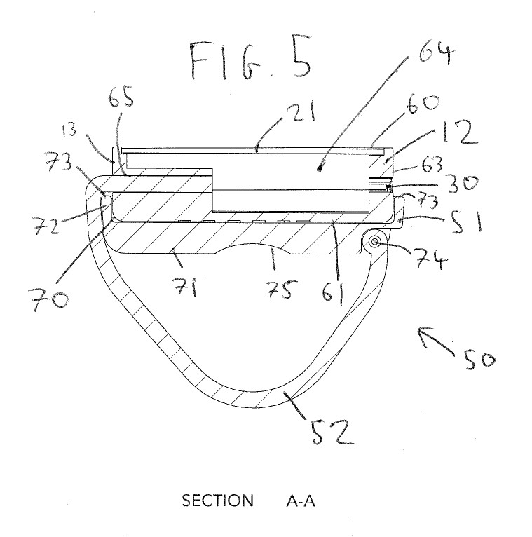

FIG. 4 is a side elevation of the navigation apparatus of FIG. 2 in the display orientation;

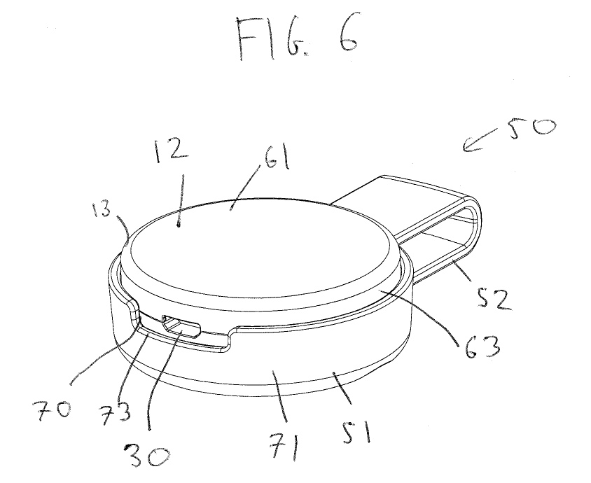

FIG. 5 is a cross-sectional side elevation the navigation apparatus of FIG. 3 through section A-A;

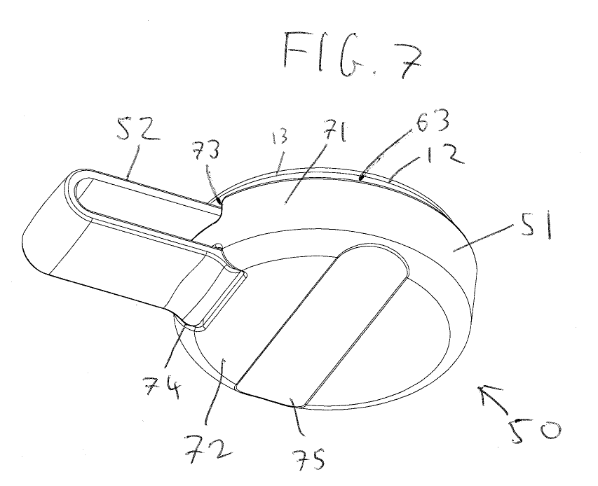

FIG. 6 is a perspective view of a navigation apparatus of FIG. 2 in a storage orientation;

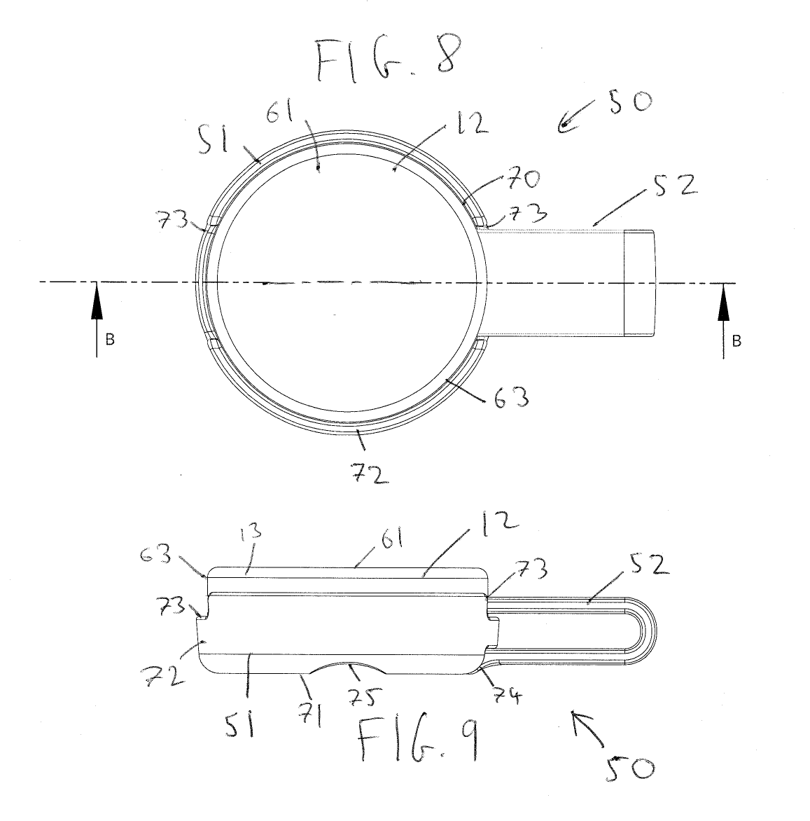

FIG. 7 is a perspective view of a the underside of the navigation apparatus of FIG. 2 in the storage orientation;

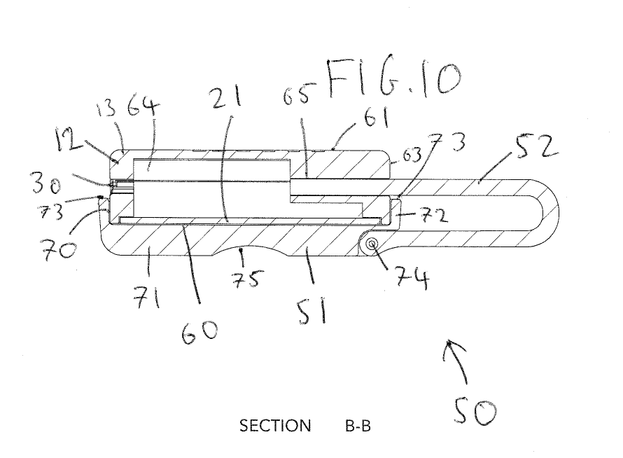

FIG. 8 is a plan view of the navigation apparatus of FIG. 2 in the storage orientation;

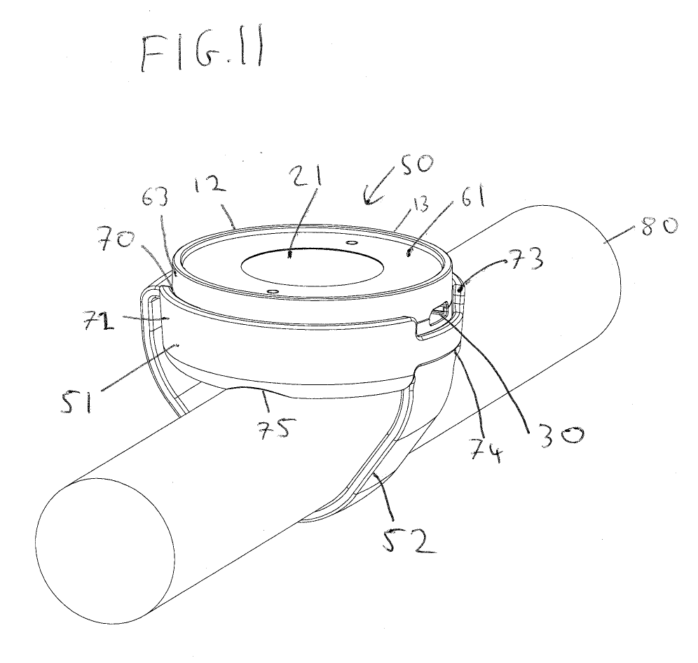

FIG. 9 is a side elevation of the navigation apparatus of FIG. 2 in the storage orientation;

FIG. 10 is a cross-sectional side elevation the navigation apparatus of FIG. 8 through section B-B;

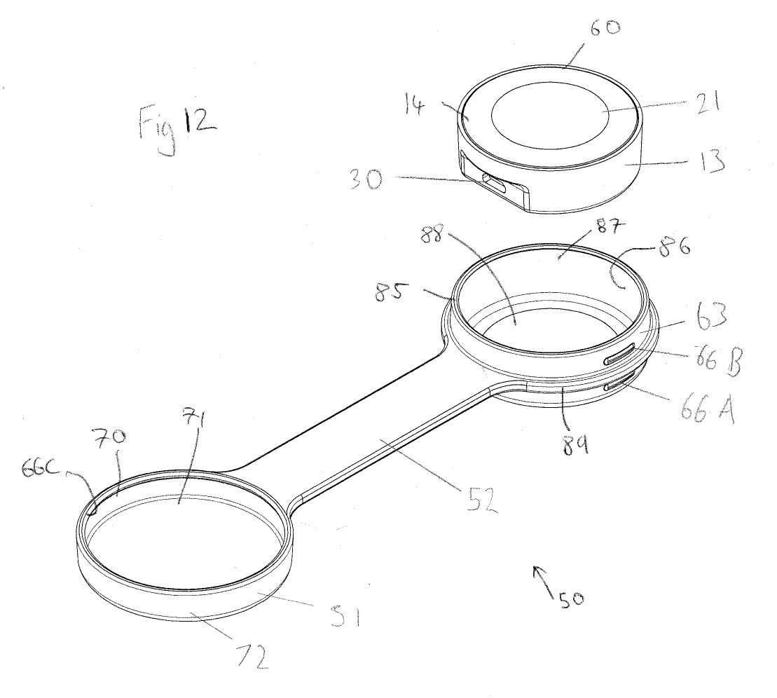

FIG. 11 is a perspective view of an apparatus comprising a bicycle component with the navigation apparatus of FIG. 2 mounted on it;

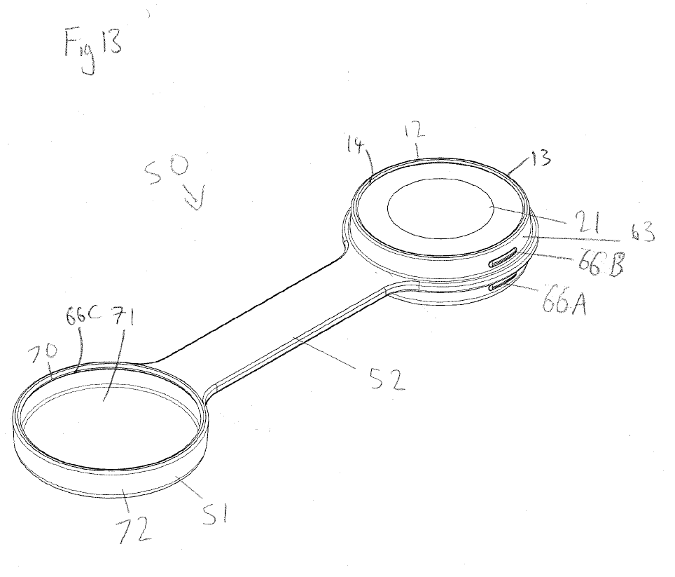

FIG. 12 is a perspective view of a further embodiment of a navigation apparatus of the present invention;

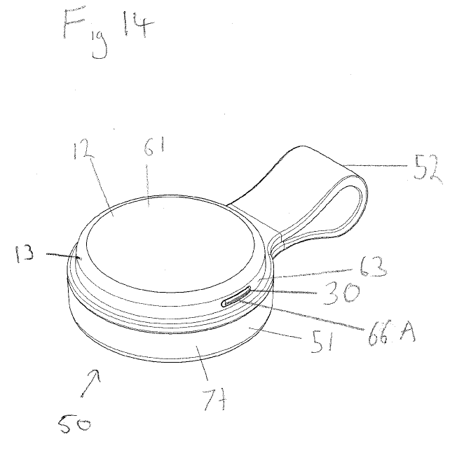

FIG. 13 is a perspective view of the navigation apparatus of FIG. 12 in a display orientation;

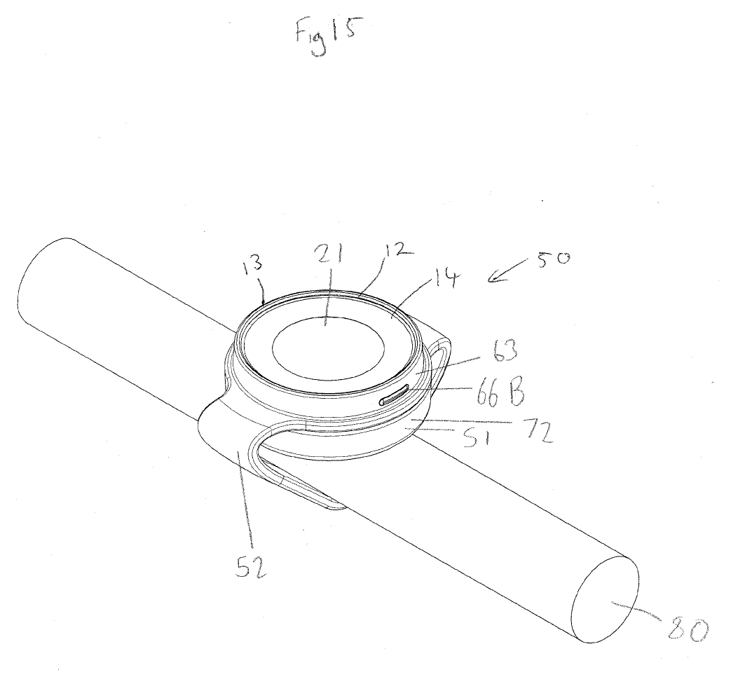

FIG. 14 is a perspective view of a navigation apparatus of FIG. 12 in a storage orientation;

FIG. 15 is a perspective view of an apparatus comprising a bicycle component with the navigation apparatus of FIG. 12 mounted on it;

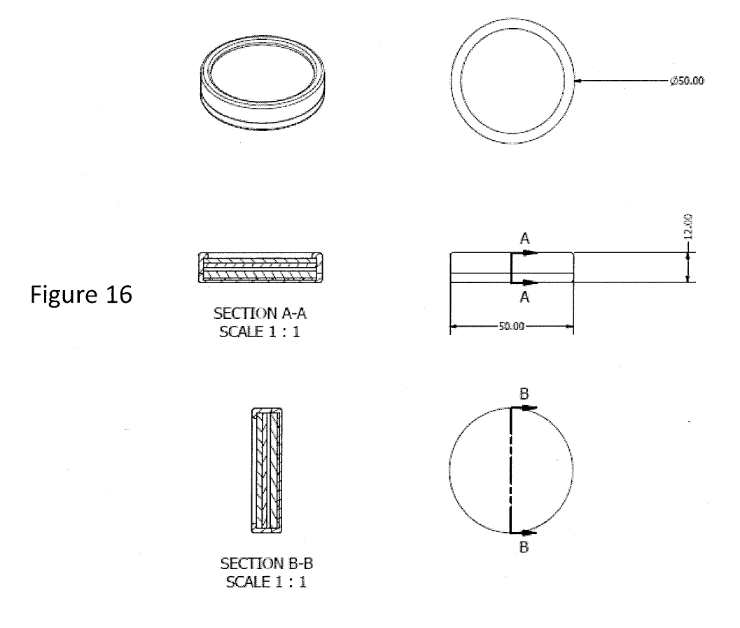

FIG. 16 shows draft orthographic projections and sections views of an embodiment of the invention (dimensions are estimates);

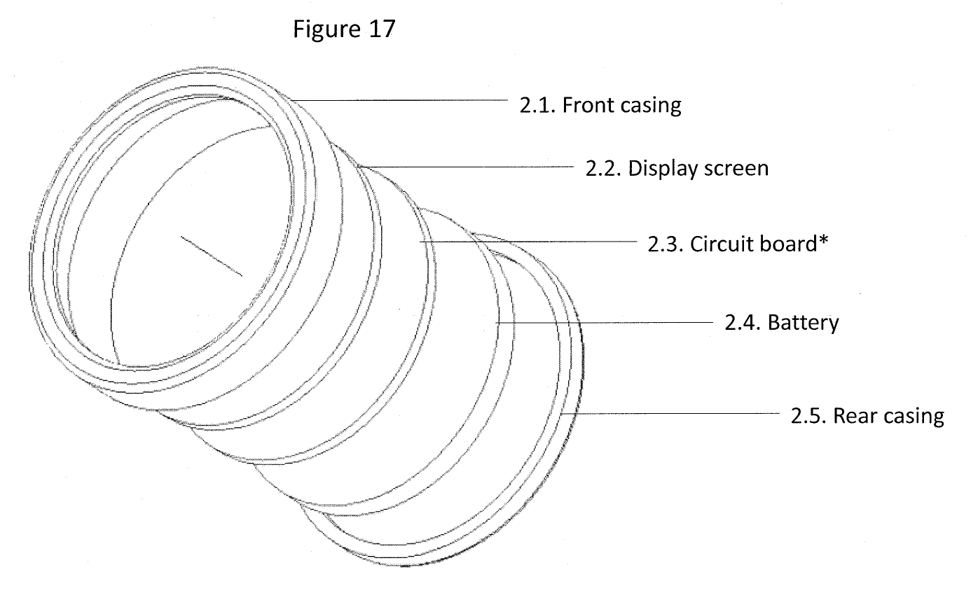

FIG. 17 shows an exploded view of an embodiment of the invention;

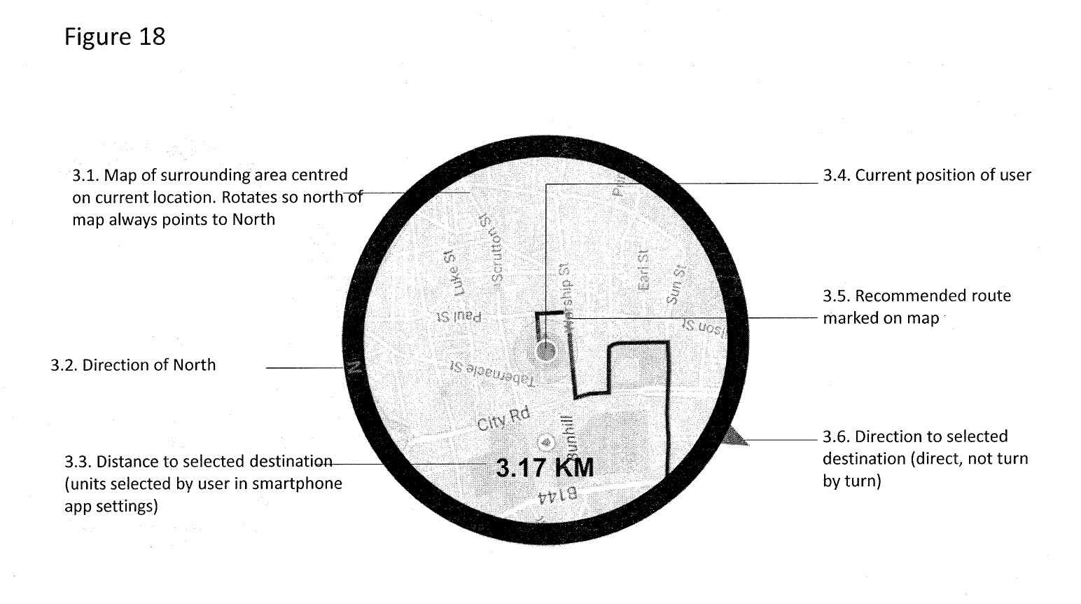

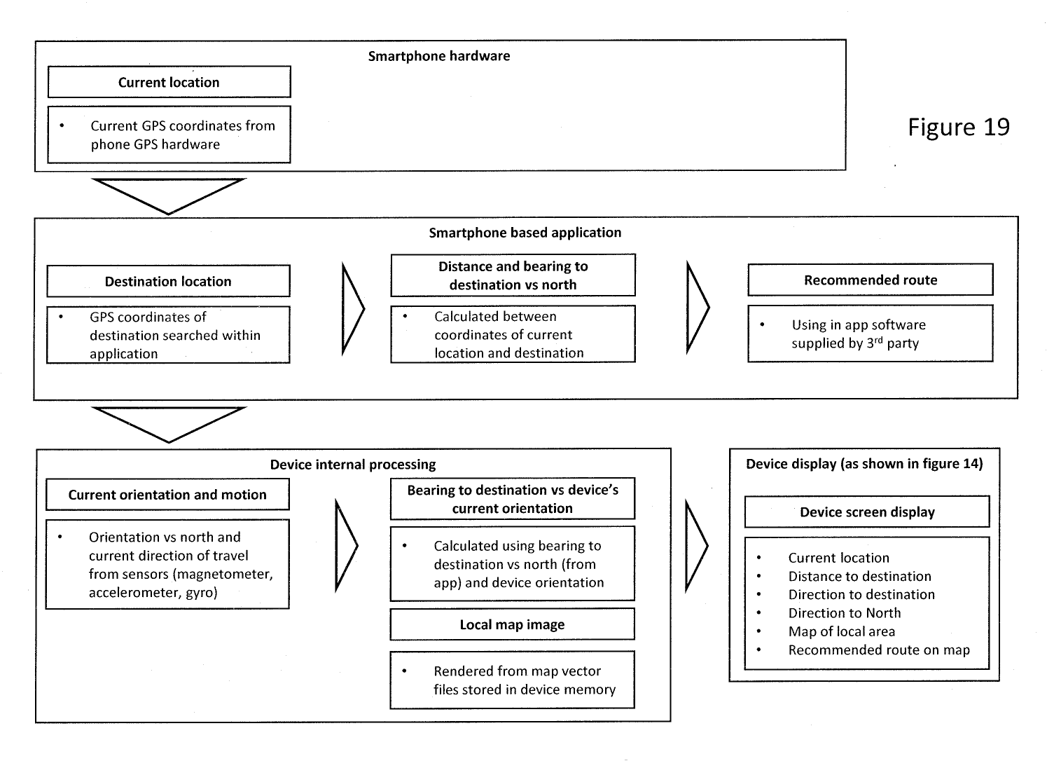

FIG. 18 shows an embodiment/demonstration of the information which will be displayed on the screen display of the invention; and

FIG. 19 shows an embodiment of the data flows showing how the invention incorporates smartphone data, a dedicated smartphone application and electronic components within the invention itself.

FIG. 1 illustrates an embodiment of a navigation system 10 of the present invention. The navigation system 10 comprises a portable computing device 11 and a navigation device 12. Preferably the portable computing device 11 is capable of determining its absolute position whilst the navigation device 12 is not capable of independently calculating its absolute position. However, the navigation device 12 is capable of determining a reference direction from which a desired direction can be determined and displayed thereon.

The navigation device 12 comprises a housing 13 and, within and/or mounted on the housing 13, a computing system 14 comprising a plurality of components in electronic communication (preferably wired communication) with one another. The computing system 14 comprises a first processing unit 20, a display 21 mounted to be visible from outside of the housing 13, at least one sensor 22, 23, 24 and first wireless communication means 25. The first processing unit 20 is operable to perform instructions from computer programs, which are preferably stored on a first memory 26 with other data, for controlling the computing system 14.

The display 21 is preferably low power consuming and is also preferably high contrast to enable it to be read easily by a user in sunlight. In particular, the display 21 may have low reflectivity of sunlight when viewed at a reading angle, may have a high refresh rate and may not have a backlight. For example, the display 21 may comprise a screen, such as a liquid-crystal-display (LCD), a memory LCD, electronic paper or electronic-ink screen, an organic light emitting diode (OLED) display, or may simply include a plurality of LEDs. The display 21 may be operable to display an indicium or indicia indicating a direction, for example in the form of an arrow or the like which may be displayed in a determined orientation relative to the housing 13 and/or display 21. The display 21 may also be operable to indicate a distance, a speed, a clock, a map or the like. Preferably the display 21 only displays two colours to conserve power. The display 21 may be round as illustrated and may have a maximum width of approximately 10 cm, more preferably approximately 7.5 cm and more preferably approximately 5 cm.

The at least one sensor 22, 23, 24 may comprise a compass 22, a gyroscope 23 and/or an accelerometer 24. In a particular embodiment all three are provided, each with three axes, as a single inertial measurement unit (IMU). Such IMU's are commonly available as “nine degrees of freedom” IMU's. The compass 22 is preferably configured to determine and provide outputs relating to the direction and magnitude of magnetic fields, particularly the magnetic field of the Earth. However, as discussed below, the output of the compass 22 may include information relating to other external magnetic fields. The compass 22 is arranged to determine a reference direction, which is preferably the direction of magnetic north, and provide a data output to the first processing unit 20 relating to the reference direction. The compass 22 may comprise any suitable digital compass or the like and is preferably a magnetometer. The compass reference direction may be based upon calibrations to account for the external magnetic fields.

The gyroscope 23 is operable to provide an angular velocity/rate to the first processing unit 20, which determines an actual angular orientation of the gyroscope 23 utilising programmed instructions and stored data from the first memory 26. The accelerometer 24 is operable to determine an acceleration and output data relating to the acceleration to the first processing unit 20. The output from the accelerometer 24 may also be used to assist in determining a reference direction of the gyroscope 23 and/or compass 22, as is known in the art.

The first wireless communication means 25 is for enabling the computing system 14 to communicate data with the portable computing device 11. It preferably consumes a relatively low amount of power and therefore will typically have a relatively short range. For example, the first wireless communication means 25 may comprise a Bluetooth® module having a class 2 or 3 radio (i.e. a specified range of up to 10 metres). Also suitable are Bluetooth low energy, Zig Bee® and ANT. The range need be little more than a few metres for use on a bicycle since the portable computing device 11 will be mounted on the bicycle itself or on the rider of the bicycle, which typically only requires a range of one to two metres.

The navigation device 12 also comprises a power supply 27 for providing power to the rest of the components of the computing system 14. The power supply 27 preferably comprises a long-life battery, such as a lithium-ion polymer battery, which is rechargeable via a power port 30. Preferably the power port 30 comprises a micro-Universal Serial Bus® port or other port for receiving a commonly available power cable. The power port 30 may also enable electronic communication with the first processing unit 20 such that the computer program instructions stored on the first memory 26 can be updated or data can be downloaded from the first memory 26 to another computing device.

The computing system 14 may also comprise at least one visual indicator 28 controlled via the first processing unit 20. In particular, a visual indicator 28 may comprise a backlight for illuminating the display 21. A light intensity sensor may be associated with the first processing unit 20 to determine ambient light intensity and the first processing unit 20 may switch the backlight on if the ambient light intensity is below a threshold value. The at least one visual indicator 28 may alternatively comprise an operation LED or the like, which indicates when the computing system 14 is off or on.

The navigation device 12 may further comprise at least one first input means 29 for receiving an input from a user and providing data indicative of the input to the first processing unit 20. The first input means 29 are preferably mounted to the outside of the housing 13. Alternatively, the first input means 29 may be mounted adjacent to the display 21. Preferably, the first input means 29 may take the form of a number of touch buttons. In an alternative embodiment the first input means 29 may be provided by a capacitive sensing continuous wheel extending substantially around the display 21. The first processing unit 20 may be programmed to associate certain sections of the capacitive wheel with certain operations. The first processing unit 20 may be operable to perform different operations dependent upon the input from the first input means 29. For example, based upon an input, the first processing unit 20 may switch the computing system 14 on or off, switch the at least one visual indicator 28 on or off or change the information shown on the display 21 (such as toggling between speeds, distances, directions, maps or the like). In a particular embodiment, described in further detail below, based upon a received input the first processing unit 20 may send instructions to the portable computing device 11 to record an absolute position or the like.

The portable computing device 11 comprises a second processing unit 40, second wireless communication means 41 for communicating with the navigation device 12, a second memory 42 storing computer program instructions for the second processing unit 40 to run, at least one second input means 43 (such as a touch screen or button), position determination means 44, cellular network communication means 45, a display (not shown), a battery (not shown) and the like. The second memory 42 is operable to store applications containing instructions which the second processing unit 40 performs based upon one or more inputs from the at least one second input means 43.

In an embodiment the portable computing device 11 is a portable communication device, a smartphone or other such mobile telephone having an internal power supply in the form of a battery and the cellular network communication means 45 is for connecting to a mobile phone wireless cellular network for transferring data and voice calls. In particular, the portable computing device 11 is capable of wireless communication with a base station at least 100 m away via the cellular network communication means 45. This is substantially different to the first wireless communication means 25 of the navigation device 12, which is only capable of communicating with another device of substantially less than 100 m away.

The second wireless communication means 41 is capable of communicating with the first wireless communication means 25 and thus they both may comprise similar features and work to similar communication protocols. The position determination means 44 is capable of determining the absolute position of the portable computing device 11. The position determination means 44 may determine the position of the portable computing device 11 by any suitable means, for example via triangulation using the cellular network communication means 45 or by interrogating a local area wireless network. However, due to the navigation device 12 being used mostly when moving across large areas, the position determination means 44 is preferably a receiver which can calculate the position of the portable computing device 11 using a navigation satellite system, particularly GPS. The position determination means may be any suitable network-based location system capable of estimating the location of the portable computing device 11. The position determination means may also comprise identifying locations of local WiFi networks and/or cell towers and estimating the location of the portable computing device 11. The position determination means may also comprise Assisted GPS, Internet Protocol (IP) address Geolocation and the like.

In a further embodiment the portable computing device 11 may not comprise the cellular network communication means 45 and instead may be any device comprising suitable second wireless communication means 41 (such as Bluetooth®) and position determination means 44 (such as GPS). For example, the portable computing device 11 may be a tablet, GPS navigation device or the like.

During operation the navigation system 10 is generally configured to perform the majority of the high power consuming and processing operations using the portable computing device 11. As a result, the size, cost, complexity and power consumption of the navigation device 12 may be reduced.

In a first operating mode the portable computing device 11 receives, via the at least one second input means 43, a desired location from a user. The desired location is an absolute location (i.e. map coordinates) the user wishes to travel to. Upon instruction from the user or otherwise, the second processing unit 40 operates the position determination means 44 to determine the current location of the portable computing device 11. In particular, the position determination means 44 may use triangulation via a navigation satellite system to determine its absolute location (i.e. map coordinates). The second processing unit 40 then calculates a desired bearing, which may be the bearing or angle required to reach the desired location from the current location relative to a reference direction. In particular, the desired bearing may be the magnetic bearing, which is the angle relative to the magnetic north (i.e. the reference direction) from the current location to the desired location.

The portable computing device 11 then transmits the desired bearing data to the computing system 14 of the navigation device 12 via the first and second wireless communications means 25, 41 and the computing system 14 determines the reference direction relative to the display 21. In particular, the first processing unit 20 receives data from the compass 22 indicating the reference direction, particularly that of magnetic north. The first processing unit 20 determines a relative reference bearing between the reference direction and a reference axis of the display 21. The navigation device 12 has therefore calculated where to indicate the reference direction on the display 21 and it may display an indicium indicating the reference direction. The navigation device 12 then calculates the position to show the desired direction, as at least one indicium, on the display 21 by, for example, subtracting the reference bearing from the desired bearing. Alternatively, the navigation device 12 may calculate the position to show the reference direction and display the desired direction at a distance from the reference direction corresponding to the magnitude of the angle of the desired bearing.

For example, a user inputs a desired position and the portable computing device 11 determines its current position. The portable computing device 11 calculates, from the absolute desired and current positions, that the desired bearing is 20 degrees clockwise from magnetic north and transmits this data to the navigation device 12. The navigation device 12 determines from the compass 22 that magnetic north is 30 degrees anticlockwise from the reference axis. The navigation device 12 therefore determines that the desired direction needs to be displayed at 10 degrees anticlockwise from the reference axis and displays an arrow at that position. The arrow may be a two dimensional shape that points in directions along the plane of the display 21, or it could be a three dimensional shape which can indicate a direction out of the plane of the display 21 (i.e. such as by appearing to point into the display 21).

In the first operating mode the aforementioned operations are performed periodically to update the desired direction shown on the navigation device 12 whilst the user is moving. In particular, at a predetermined transmission rate the portable computing device 11 determines a current position, recalculates the desired bearing and sends it to the navigation device. At a predetermined display refresh rate the navigation device 12 redetermines the reference direction, recalculates the desired direction and updates the display 21. A suitable transmission rate is approximately 0.5 Hz. The transmission rate may also be controlled based upon the distance from the current location to the desired location. In particular, as the distance is reduced the transmission rate may increase. For example, when the distance is more than 1 km the transmission rate may be less than approximately 1 Hz, such as 0.5 Hz, 0.1 Hz or 0.03 Hz. When the distance is less than 1 km, or more preferably less than approximately 500 or approximately 100 m, the transmission rate may be more than 1 Hz, such as approximately 2 Hz or approximately 5 Hz.

A display refresh rate of approximately 10 Hz to approximately 30 Hz is suitable, although it needs to be selected to ensure that power consumption is kept relatively low. The display refresh rate may be up to 60 Hz. This refresh rate ensures that the displayed desired direction updates as navigation device 12 moves such as, for example, if it is mounted on handlebars and the user rotates the handlebars the indicium will move around the display 21 to always point in the desired direction. The display refresh rate may be adaptable such that when a change in the desired direction is less than a threshold value the display 21 is not refreshed, thereby saving power consumption.

In the first operating mode the computing system 14 determines a compass reference direction and a gyroscope reference direction, which are preferably substantially the same. Provided that any difference between the compass and gyroscope reference directions remains below a threshold magnitude or rate of change, the first operating mode continues as described above. The gyroscope reference direction is determined based upon the angular change since a previous reading stored on the first memory 26. The data stored on the first memory 26 relating to gyroscope reference direction may be periodically calibrated to the compass reference direction because, during use, they may drift out of alignment. In particular, the gyroscope 23 provides an output of the angular rate of change and a new angle, relative to a previous angle, may be determined by integrating the output over a time period since the reading of the previous angle. Therefore, the previous angle (which may be the previously sampled gyroscope reference direction) may be stored on the first memory 26, the output of the gyroscope 23 sampled over a sample time period and the new angle may be based upon the integration of the sample outputs over the sample time period. The gyroscope reference direction may be based upon this new angle.

However, in the first operating mode the navigation device 12 may suffer from inaccuracies due to incorrect readings of the reference direction by the compass 22. For example, such incorrect reading may occur as a user passes close to large metallic objects, such as buildings, bridges or the like. For this reason, the second operating mode may be implemented in which the gyroscope 23 is used as the source of the reference direction. Therefore, if the difference between the rate of change of the compass reference direction and rate of change of the gyroscope reference direction is above a threshold value, or the difference between them changes above a threshold value, the second operating mode may be implemented. In the second operating mode the navigation device 12 uses the reference direction output from gyroscope 23 to determine the desired direction in a broadly similar method to that outlined above in respect of the first operating mode. As the output of the gyroscope 23 is periodically calibrated to the compass reference direction, the gyroscope reference direction may also be based upon the direction of magnetic north. The computing system 14 may implement the first operating mode once the difference has fallen below the threshold magnitude.

In an alternative embodiment of the first and second operating modes, the navigation device 12 may predominantly utilise the reference direction output of the gyroscope 23 to determine the desired direction. The gyroscope 23 may be periodically calibrated (to compensate for sensor drift and noise) utilising the compass reference direction calculated from the compass 22. As the output of the gyroscope 23 is periodically calibrated to the compass reference direction, the gyroscope reference direction may also be based upon the direction of magnetic north. Therefore, the desired direction can be calculated based upon the gyroscope reference direction and the desired bearing, which is the desired bearing relative to magnetic north.

The navigation device 12 may be operable to assign a confidence parameter to the compass reference direction. The confidence parameter may be based upon, for example, the recent rate of change of the magnitude and/or direction output of the compass 22 and/or the deviation of the magnitude and/or direction output of the compass 22 from a certain value by a threshold magnitude. In particular, the navigation device 12 may store upon the first memory 26 (which may be communicated from the portable computing device 11) details relating to the expected strength of the magnetic field of the Earth at the location of the navigation device 12 (such as those from the World Magnetic Model). Any significant deviations from the expected field strength may result in a lower confidence parameter. If the confidence parameter is above a confidence threshold value, the navigation device 12 may calibrate the output of the gyroscope 23 to the compass reference direction.

In any embodiment, the navigation device 12 may also calibrate the output of the compass 22 to account for, in the compass reference direction, external magnetic fields unassociated with the magnetic field of the Earth. Such external magnetic fields include those inherent within components of the navigation device 12, vehicles upon which the navigation device 12 is mounted (such as bicycles) and large metallic objects, such as buildings, bridges or the like. For example, a magnitude of change in the output of the compass 22 above a threshold value may be determined. If the magnitude of change remains constant for a threshold time period (such as when the navigation device 12 is moved close to and mounted onto a bicycle), then the navigation device 12 may store the magnitude value and its direction as an external magnetic field vector on the first memory 26. As the vector output of the compass 22 changes as the navigation device 12 is moved, the navigation device 12 may determine the compass reference direction by accounting for the external magnetic field vector. For example, the compass reference direction may be determined by subtracting external magnetic field vector from the compass vector output.

The computing system 14 may determine the reference direction relative to the display 21 accounting for different orientations of the navigation device 12, particularly by utilising the output from the accelerometer 24 and/or gyroscope 23. Such an arrangement is particularly suitable in the case of having a three degree of freedom accelerometer 24, compass 22 and gyroscope 23 as the tilt and pitch of the navigation device 12 (such as when mounted on moving handlebars of a bicycle) and the inclination of the direction of the Earth's magnetic field can be accounted for in the display of the desired direction.

The output data of the accelerometer 24 may relate to a combination of the acceleration of the navigation device 12 and acceleration due to the gravitational force of the Earth. The computing system 14 may therefore operate the accelerometer 24 to determine the relative orientation, particularly the tilt or pitch, between a reference orientation of the navigation device 12 (such as along the reference axis or orientation of the display 21) relative to the direction of the gravitational force of the Earth. The compass and gyroscope reference directions may be determined relative to the same reference orientation. Therefore, when determining the relative reference bearing between the compass and/or gyroscope reference direction and the reference axis of the display 21, the computing system 14 can use the relative orientation to account for any variations of the desired direction based upon the orientation of the navigation device 12.

The projection of a desired direction on the display 21 when the plane of the display 21 is not horizontal (such as if it were mounted on a recumbent bicycle) is therefore improved. For example, if the navigation device 12 is pitched at an angle that is orthogonal to the direction of the Earth's magnetic field (i.e. the plane of the display 21 is vertical), the output of a compass 22 would indicate a direction orthogonal to the plane of the display 21, which, without knowing the orientation of the navigation device 12, cannot be easily resolved into a direction of magnetic north. However, by determining the output of the compass 22 relative to the reference orientation and determining the relative orientation of the device (i.e. using the output of the accelerometer 24), it is possible to resolve the direction of magnetic north relative to the orientation of the navigation device 12. The identification of the direction of magnetic north relative to the orientation of the navigation device 12 can then be incorporated into the calculation of the relative reference bearing (in three dimensions) between the reference direction and a reference axis of the display 21. The relative reference bearing may be such that the reference direction can be projected in the plane of the display 21 that a user can understand (such as by pointing upwards, which according to convention would be north). Tilt (i.e. side to side movement) of the navigation device 12 can be similarly accounted for. Furthermore, in a similar manner, the inclination of the output of the compass 22 in determining the compass reference direction can be accounted for and removed. The inclination is represented in components of the magnetic field vector output of the compass 22 that are not along the horizontal plane of the Earth (i.e. components pointing into the Earth).

Compensations to the desired direction and/or desired bearing may be made in order to account for the magnetic declination between magnetic north and true north. Data relating to the magnetic declination may be stored on the portable computing device 11 or navigation device 12 and may be updated depending upon their location. In particular, the portable computing device 11 may determine its location and download suitable magnetic declination data associated with the location from a network. The magnetic declination data may be based upon the World Magnetic Model.

A third operating mode may be implemented in which the reference direction from the compass 22 or gyroscope 23 may not be used to indicate the direction on the navigation device 12. Instead, the portable computing device 11 calculates its direction of travel by sequentially determining at least three absolute positions, each being separated by a predetermined time period. If the absolute positions are in a substantially straight line (i.e. indicating that the portable computing device 11 is travelling in a substantially straight direction) then the portable computing device 11 determines that the straight line is the travel direction. The third operating mode may be implemented when the portable computing device 11 determines that it can calculate the straight line above a threshold accuracy. The threshold accuracy may be reached when the portable computing device 11 is travelling above a certain speed such that the at least three absolute positions are spaced apart by at least a threshold difference or when the position determination means 44 can calculate the absolute positions within a predefined accuracy.

The desired bearing is determined as the relative bearing between the travel direction and the desired direction, the latter being calculated as the direction from the current absolute position to the desired absolute position. The portable computing device 11 sends the desired bearing to the navigation device 12. The computing system 14 is programmed with a reference direction of travel of the navigation device 12, which is preferably the reference axis. The display 21 is operated to display the desired direction, based upon the desired bearing and reference direction of travel. As a result, any inaccuracies in the gyroscope 23 and/or compass 22 may be avoided at high speeds of travel.

During the third operating mode the reference direction from the gyroscope 23 may be used by the computing system 14 to determine if the navigation device 12 has changed orientation above a threshold rate of change, such as if it is located on handlebars of a bicycle and the handlebars are rapidly moved. The first or second operating mode may be implemented in this case, or the output reference direction from the gyroscope 23 may used in combination with the reference direction of travel and desired bearing from the portable computing device 11 to update the desired direction shown on the display 21.

A fourth operating mode may be implemented if the at least one input means 29 of the navigation device 12 receives an input from a user. In particular, the first processing unit 20 receives an input signal, interprets the input signal and operates the first wireless communication means 25 to send input data to the portable computing device 11. In a particular embodiment, the input data may comprise instructions for the portable computing device 11 to determine its absolute position and store the coordinates of the absolute position on its second memory 42. The user can then retrieve these coordinates later. For example, a user may wish to “tag” a location on a social network or the like. They operate the at least one input means 29 and the portable computing device 11 stores the location. The user can then upload the coordinates of the stored location to the social network after they have finished the journey. Alternatively, the coordinates may be retrieved for the user to later see the stored location on mapping software or for the user to use a search engine on the Internet to look for a facility (e.g. a particular shop or the like) close to the stored location.

Alternatively, the user may provide an input to the input means 29 to instruct the portable computing device 11 to determine and store the coordinates of the absolute position on its second memory 42, along with data relating to a review tag. The review tag may be positive or negative which may depend upon the input means 29 selected. The absolute position and review tag data may be sent on to an external server via, for example, the cellular network communication means 45 and/or a network, such as the Internet. The external server may then collate received review data from a number of devices in a database and generate a model of preferred and disliked areas for, for example, cycling (or any other activity utilising the navigation system 10 of the present invention) based upon the positive and negative review tag data.

A fifth operating mode may be implemented if the magnitude of an output from the accelerometer 24 exceeds an accelerometer threshold value. The first processing unit 20 receives the accelerometer data, compares it with the accelerometer threshold value and, if above the accelerometer threshold value, operates the first wireless communication means 25 to send the accelerometer data to the portable computing device 11. This accelerometer data may be stored on the second memory 42 of the portable computing device 11, preferably with the absolute location at which the accelerometer data was captured. The absolute location data and accelerometer data may be sent to an external server via, for example, the cellular network communication means 45 and/or a network, such as the Internet.

In a particular embodiment the accelerometer threshold value may be determined based upon a predetermined acceleration associated with an impact with aspects of the terrain over which the navigation device 12 is travelling. For example, the predetermined acceleration may be based upon the expected impact experienced by a bicycle hitting a pothole or the like. As a result, the external server may build a database of the location of potholes. This database may be used by local authorities of the like to determine where road repairs are needed or may be used by the portable computing device 11 to determine which directions to avoid as they would involve passing over a threshold number of potholes.

In yet a further embodiment the accelerometer threshold value may be determined based upon a predetermined acceleration associated with a rapid change in direction in which the navigation device 12 is travelling, such as if a user on a bicycle swerves to avoid an object. As a result, the external server may build a database of the location of rapid changes in direction indicating areas in which dangerous or potentially hazardous cycling occurs. This database may be used by local authorities of the like to determine where transport infrastructure changes are required. Alternatively, it may be used by the portable computing device 11 to determine which paths to avoid as they would involve passing over a threshold number of dangerous or potentially hazardous areas.

In another embodiment, an acceleration threshold value may be determined based upon a predetermined acceleration or deceleration associated with the speed of travel of the navigation device 12, such as when speeding up and slowing down regularly in heavy traffic. The acceleration or deceleration in this case may be determined utilising the output from the accelerometer 24 of the navigation device 12 and/or via the position determination means 44 of the portable computing device 11. As a result, the external server may store a plurality of such data from a plurality of navigation devices in order to populate a database of the absolute positions of frequent acceleration and deceleration, thereby indicating locations of heavy traffic. The portable computing device 11 may also send timestamp data with which the acceleration data is associated. This timestamp data may be stored by the external sever along with the acceleration and location data so that the database can associate heavy traffic with particular routes at particular times. This database may be used by local authorities or the like to determine where transport infrastructure changes are required. Alternatively, it may be used by the portable computing device 11 when generating waypoints (see below) to avoid certain routes.

A sixth operating mode may be implemented in which data is calculated on the portable computing device 11, sent to the navigation device 12 and shown on the display 21. The data calculated may be the distance from the current absolute position to the desired position, the current speed of travel and/or map data. The map data may contain instructions for displaying a map the local area to the current absolute position. The map data may be downloaded from an external server to the portable computing device 11. The local area displayed may be up to approximately 500 m, approximately 1000 m or approximately 2000 m from the current absolute position.

A seventh operating mode may be implemented in which the portable computing device 11 breaks the journey between the current location and desired location with waypoints. The waypoints may not correspond to every required movement (i.e. not every turn at every junction), but only comprise a few waypoints between the current and desired location. In particular, less than fifty waypoints, less than twenty-five waypoints, less than ten waypoints or less than five waypoints may be calculated. The waypoints may be automatically generated by the portable computing device 11, possibly via the network and external servers, or they may be input by the user via the at least one second input means 43. The portable computing device 11 operates as per the first operating mode, updating the desired location to the next waypoint during the journey. The user may operate a first input means 29 on the navigation device 12 to move between the waypoints. For example, once the distance displayed to a user reaches close to zero, the user may operate the first input means 29 and a signal is sent via the first processing unit 20 and first wireless communication means 25 to the portable computing device 11. The portable computing device 11 updates the desired location to the next waypoint and sends updated distance data and an updated desired bearing to the navigation device 12 for updating the display 21. Alternatively, the portable computing device 11 may update the desired location to the next waypoint automatically without receiving an input from the user. The navigation device 12 may be operable to indicate when a change in waypoints is approaching, such as by displaying an indicium or the like on the display 21.

The first to seventh operating modes may be implemented separately, simultaneously and/or sequentially. Furthermore, other operating modes may also be implemented. Furthermore, each of the first to seventh operating modes may be implemented on external servers, the portable computing device 11 and/or the navigation device 12 where appropriate.

The portable computing device 11 may store an application associated with the navigation device 12 on its second memory 42 and run the application as computer program instructions for the second processing unit 40. The application may be configured to download and/or populate the second memory 42 with data from the navigation device 12 and/or data received from an external server via, for example, the cellular network communication means 45 and/or a network, such as the Internet. The application may be configured to operate the portable computing device 11 to perform the aforementioned operating modes and different functions based on this data. The application may be configured to operate the portable computing device 11 to show different “pages” or interfaces on the display of the portable computing device 11. The application may be configured to retrieve data from the external server associated with one or more other user profiles. The application may be configured to perform certain functions or operate the display in a manner associated with a user profile stored on the portable computing device 11 and/or the external server. The application may be configured to combine a historical absolute location data, which may be stored on the external server or portable computing device 11 in association with a user profile, and map data from an external server in order to produce a view or report of the trip as it is in progress or once it has finished. The historical absolute location data of different user profiles may be downloaded from the external servers for comparison the historical absolute location data of the loaded user profile. This comparison may form the basis of data analysis, training instruction or games which may be played by the users in which they compete to complete routes in certain time periods.

The navigation device 12 is particularly suitable for mounting on a bicycle and the portable computing device 11 is typically stored in the bicycle rider's bag or pocket or on the bicycle itself. In the present disclosure, “bicycle” may refer to any human and/or motor powered bicycle. FIGS. 2 to 11 illustrate a navigation device apparatus 50 comprising the navigation device 12, a mount 51 for mounting the navigation device 12 to a bicycle and a strap 52 connecting the mount 51 to the navigation device 12.

The navigation device 12 of the illustrated embodiment comprises the housing 13 with first and second sides 60, 61, which may be substantially circular, connected by a wall 63, which may be substantially circular. The housing 13 may be formed from two parts as illustrated and have a waterproofing means therebetween, such as a silicone gasket. The display 21 is located in the first side 60 and the power port 30 is located on the wall 63. As shown in FIGS. 5 and, 10, the navigation device 12 comprises an internal volume 64 for containing the computing system 14 (not shown in FIGS. 2 to 11).

The navigation device 12 further comprises fixing means 65 to which the strap 52 is attached. In the illustrated embodiment the fixing means 65 comprises a recess through the wall 63, although the fixing means 65 may comprise any other suitable fixing means, including adhesive, screws or an integral molding between the housing 13 and strap 52.

The mount 51 is arranged to receive the navigation device 12 in a display orientation, in which the mount 51 supports the navigation device 12 such that the display 21 is readable by a user (see FIGS. 2 to 5 and 11), and in a storage orientation, in which the display 21 is covered by the mount 51 (see FIGS. 6 to 10).

The mount 51 comprises a recess 70 for receiving the housing 13 of the navigation device 12. The recess 70 is shaped to match the shape of the housing 13 and thus comprises a base 71 and a wall 72 surrounding and extending from the base 71. In the illustrated embodiment the base 71 is substantially circular and the wall 72 forms a substantially hollow circular tube. The wall 72 may comprise one or more cut-outs 73 for enabling access to parts of the navigation device 12, such as the power port 30. The mount 51 may comprise fixing means 74 for securing to the strap 52, which may comprise a pin and recess as illustrated or any other suitable means.

The underside of the mount 51 further comprises a recess 75, which may be a curved recess as shown, for fitting to a bicycle component. In particular, the recess 75 may be curved to shape the handlebars of a bicycle.

In the illustrated embodiment, the navigation device 12 is securely held in the mount 51 by interference and/or friction in both the storage and display orientations. However, the navigation device 12 and/or mount 51 may further comprise mounting means thereon for enabling a secure hold between the mount 51 and navigation device 12. For example, the mounting means may comprise tabs on the housing 13 and recesses on the wall 72 for receiving the tabs. Alternatively or in addition, the mounting means may comprise a screw extending through threaded passageways in the mount 51 to the housing 13. Preferably the screw comprises a head which can only be turned by a special tool such that it cannot be removed easily by thieves.

In the display orientation the navigation device 12 is inserted into the recess 70 of the mount 51 such that the first side 60 of the navigation device 12 points upwardly (i.e. towards a user) and away from the base 71 of the mount 51. The second side 60 is adjacent to the base 71. A user can therefore read the display 21.

In the storage orientation the navigation device 12 is inserted into the recess 70 of the mount 51 such that the first side 60 of the navigation device 12 is adjacent to the base 71. The second side 61 faces away from the base 71. The display 21 is therefore covered within the recess 70 and will avoid being damaged during storage.

The strap 52 is substantially elastic strap and extends between the navigation device 12 and mount 51. The strap 52 may, for example, be formed of silicone or the like. The strap 52 is arranged to wrap around a bicycle component 80 to fix the mount 51 and navigation device 12 in the display orientation to the bicycle component 80 (as shown in FIG. 11). In particular, the strap 52 will be put under tension as it is wrapped around the bicycle component 80 such that the mount 51 is held in an upright position for a user to read the navigation device 12 by friction between the strap 52, mount 51 and bicycle component 80. Furthermore the tension of the strap 52 may increase the friction and/or interference between the mount 51 and navigation device 12 such that the navigation device 12 is held securely within the recess 70 of the mount 51.

The bicycle component 80 may be any suitable component, including handlebars, a stem, a frame top tube, a headset or the like. In alternative embodiments the navigation device 12 may be attached to other components, such in place of the top cap of the headset or the like.

A further embodiment of the navigation device apparatus 50 is depicted in FIGS. 12 to 15. The navigation device 12 comprises the housing 13, containing the computing system 14, which is removable from the recess 86 of a secondary mount 85, as shown in FIG. 12. The secondary mount 85 may be connected to the mount 51 by the strap 52. The computing system 14 may be inserted in a display orientation as shown in FIGS. 13 and 15, wherein the display 21 is visible. The navigation device 12 may be rotated and inserted in a storage orientation to further protect the display from damage. In addition, the mount 51 may be fixed over the navigation device 12 and secondary mount 85 in the storage or display orientation as shown in FIG. 14.

The secondary mount 85 may comprise a cylindrical wall 87 extending upwards from a base 88, defining the recess 86 therebetween. The cylindrical wall 87 may comprise an annular protrusion 89 around its outer surface to define a stop against which the mount 51 abuts when the secondary mount 85 is inserted into the recess 70 of the mount 51 (as in FIGS. 14 and 15).

The secondary mount 85 and mount 51 may further comprise complementary mounting means 66A, 66B, 66C for securing the secondary mount 85 inside the recess 70 of the mount 51. In particular the mounting means 66A, 66B of the secondary mount 85 may comprise tabs extending from the outer surface of the cylindrical wall 87. The mounting means 66C of the mount 51 may comprise a lip extending inwardly from the inner periphery of the edge of the wall 72 opposite the base 71. The tabs may be press fitted under the lip to provide an engagement such that substantial force needs to be applied by a user to remove the secondary mount 85 from the mount 51.

Besides these differences, the navigation device apparatus 50 operates as described in detail above for the first embodiment.

The present invention provides a city navigation device, primarily for use on bicycles (the “Invention”). This Invention relates to a navigation hardware device (“Device”), paired to the user's smartphone (by Bluetooth® or other wireless data transfer). When travelling around cities, cyclists and pedestrians often need light navigational support, but not detailed turn-by-turn directions to their destination. Most cyclists and pedestrians carry a smartphone in their pocket which has the power to provide much of the navigational information required, but it is often carried in a pocket or bag and hence not in the user's field of vision. City cycling could be made much easier, safer and more fun with the use of a simple device, harnessing the power of the smartphone, to display simple navigation information in the user's field of view (e.g. attached to the handlebars of a bicycle.

To overcome this, the Invention proposes the Device consisting of position and motion sensors (magnetometers, gyroscopes, accelerometers) a Bluetooth® receiver, processing power and a screen to pair/connect with a smartphone and display simple distance and direction information to the user along with a recommended route and a map of the surrounding area.

The Device will use three stages of information and processing: (1) location sensors in the smartphone; (2) recommended route, distance to destination and absolute bearing to destination (bearing from North) in a dedicated application (software) on the smartphone; and (3) bearing vs current orientation and display of information (distance and bearing to destination, recommended route and map of surrounding area centred on current location). Using these three stages of information and processing the Device will display to the user: the direction (bearing) to selected destination; the distance to selected destination; a map of the surrounding area; their current location on map of surrounding area; and a recommended route on the map of surrounding area. Together these pieces of information will allow the user to navigate to their destination in an effective, safe and fun way

The advantages of this invention compared to other current navigation solutions are:
Safety: no audio instructions mean the user can hear everything happening in their surroundings (including potentially dangerous traffic and vehicles); by not showing visual turn by turn instructions which require the user to watch the screen at specific moments, the user is free to watch the road at crucial moments (junctions, turns etc.); by showing the recommended route, not turn by turn instructions the user can prepare to take action well in advance (turn by turn instructions often give very late instructions which can be dangerous in traffic); by showing the recommended route and bearing to destination the user is more able to make their own alterations to the route if they are uncomfortable with that suggested by the navigation system; by showing only the key information, not turn by turn instructions, the user spends less time looking at the navigation system, leaving more time to watch the road,
Effectiveness: by showing the recommended route and bearing and distance to destination, the user is at liberty to select their own route as they progress, which is often a shorter or faster one than that suggested by other navigation systems,
Fun: by not being prescriptive but showing information to assist the user make their own navigation decisions, the user has more control over their route and is more engaged in the journey. This gives a sense of freedom and exploration to the travel experience.

In FIG. 17 the circuit board 2.3 includes a Bluetooth receiver/transmitter, a magnetometer, a gyro (3 DOF) an accelerometer (3 DOF) a memory chip and a processor. FIG. 19 shows data flows between smartphone sensors, smartphone application and device hardware.

A smartphone based application installed on the user's phone takes the GPS coordinates of the user's current location and the GPS coordinates of a destination selected by the user and calculates the distance and bearing in (in degrees or mils) from the current location to the destination location. The smartphone app also calculates a recommended route from the current location to the destination.

These pieces of information are sent to the device via a Bluetooth® (or other wireless) connection. The Device then uses its sensors, stored data and processor on the circuit board (see FIG. 17 and FIG. 19) to present the navigation information required on the device screen. Namely:
Distance to destination: taken directly from the smartphone app via Bluetooth® (or other wireless connection).
Bearing to destination: calculated as the bearing to north taken from the smartphone app, minus the current bearing of the device (taken from the device magnetometer, gyro and accelerometer sensors).
The map of the surrounding area: taken from map vector files stored on the device and presented centred on the current location using the current GPS coordinates taken from the smartphone sensors via the smartphone application.
The recommended route: using map route data sent from the smartphone application and presented overlaid on the device map display by the device processors.

This information is sent and recalculated on a regular basis (several times per second) to keep the display current. As the user rotates the Device, the map display, recommended route, direction to destination and bearing to destination also rotate such that they are always accurate relative to the fixed North-South reference. As the user moves towards (or away from) the destination, the distance display will update to reflect this change.

1. A navigation system comprising a navigation device for receiving navigation data from a portable computing device, the navigation device comprising:
a display;
at least one sensor configured to determine a reference direction, the reference direction being a direction relative to the display;
wireless communication means for wirelessly receiving data relating to a desired bearing from a portable computing device; and
a processing unit connected to the display, the at least one sensor and the wireless communication means, the processing unit being configured to:
receive a desired bearing from the wireless communication means;
receive the reference direction from the at least one sensor;
determine a desired direction based upon the reference direction and desired bearing; and
operate the display to display an indicium for indicating the desired direction relative to the display.

2. A navigation system as claimed in claim 1 wherein the reference direction is based upon the direction of magnetic north and the desired bearing is an absolute bearing relative to the direction of magnetic north.

3. A navigation system as claimed in claim 2 wherein the reference direction and/or desired bearing are adapted to account for magnetic declination between magnetic north and true north.

4. A navigation system as claimed in claim 3 wherein the at least one sensor comprises a compass and/or a gyroscope and the reference direction is based upon the output of the compass and/or gyroscope.

5. A navigation system as claimed in claim 4 wherein the processing unit is configured to receive a compass reference direction and calibrate a gyroscope reference direction based on the compass reference direction.

6. A navigation system as claimed in claim 5 wherein the processing unit is configured to:
determine compass and gyroscope reference directions;
determine a desired direction based upon the gyroscope reference direction;
determine a confidence parameter associated with the compass; and
if the confidence parameter meets a threshold value, calibrate the gyroscope to the compass reference direction.

7. A navigation system as claimed in claim 4 wherein the processing unit is configured to:
receive outputs from the compass and gyroscope;
determine whether a magnitude or rate of change relating to the outputs of the compass and/or gyroscope are greater than a threshold value; and
determine a desired direction based upon the gyroscope reference direction and the desired bearing if the magnitude or rate of change meets a threshold value; or
determine a desired direction based upon the compass reference direction and the desired bearing if the magnitude or rate of change does not meet the threshold value.

8. A navigation system as claimed in claim 1 wherein:
the wireless communication means is for receiving map and/or distance data; and
the processing unit is configured to receive the map and/or distance data from the wireless communication means and operate the display to show the map and/or distance data.

9. A navigation system as claimed in claim 4 wherein the compass is a magnetometer.

10. A navigation system as claimed in claim 1 wherein the at least one sensor comprises an accelerometer and the processing unit is configured to receive acceleration data from the accelerometer.

11. A navigation system as claimed claim 4 wherein the processing unit is configured to determine an orientation of the navigation device utilising the accelerometer and/or gyroscope and determine the reference direction based upon the orientation of the navigation device.

12. A navigation system as claimed in claim 4 wherein processing unit is configured to determine the compass reference direction accounting for any external magnetic fields other than that of the Earth.

13. A navigation system as claimed in claim 1 further comprising at least one input connected to the processing unit, the processing unit being configured to send data to the portable computing device via the wireless communication means.

14. (canceled)

15. A navigation system as claimed in claim 1 and a portable computing device comprising wireless communication means for wireless communication with the wireless communication means of the navigation device.

16. A navigation system as claimed in claim 15 wherein the portable computing device comprises:
position determination means for determining the absolute position of the portable computing device;
at least one input means for receiving an input from a user relating to a desired position; and
a further processing unit configured to determine a desired bearing based upon the absolute position and the desired position and send the desired position to the navigation device via the wireless communication means.

17. A navigation system as claimed in claim 16 wherein the further processing unit is configured to:
determine a travel direction of the portable computing device based upon sequential determinations of the absolute position of the portable computing device;
determine a desired bearing as a relative bearing between the travel direction and a desired direction, the desired direction being that from the absolute position and the desired position; and
send the desired bearing to the navigation device,
wherein the processing unit of the navigation device is configured to:
determine a desired direction based upon the desired bearing and a reference direction of travel of the navigation device; and
indicate the desired direction on the navigation device.

18. A method of operating a navigation system comprising a navigation device, the navigation device comprising a display, at least one sensor, wireless communication means and a processing unit, wherein the method comprises:
determining a reference direction of the navigation device via the at least one sensor;
receiving at the navigation device a desired bearing from a portable computing device via the wireless communication means;
operating the processing unit to determine a bearing difference between a desired direction based upon the reference direction and desired bearing; and
operating the display to display an indicium, the indicium being oriented relative to the display based upon the desired direction.

19. A method as claimed in claim 18 wherein the at least one sensor comprises a compass and a gyroscope and the method comprises:
receiving, at the processing unit of the navigation device, outputs from a compass and a gyroscope;
operating the processing unit to:
determine whether a magnitude or rate of change relating to the outputs of compass and gyroscope meets a threshold value; and
determine a desired direction based upon a gyroscope reference direction and the desired bearing if the magnitude meets the threshold value; or
determine a desired direction based upon a compass reference direction and the desired bearing if the magnitude does not meet the threshold value.

20. A method as claimed in claim 19 wherein the system further comprises a portable computing device, the portable computing device comprising wireless communication means, position determination means, at least one input means and a further processing unit, wherein the method further comprises:
determining the absolute position of the portable computing device via the position determination means;
receiving an input relating to a desired position at the at least one input means;
determining, via the further processing unit, a desired bearing based upon the absolute position and the desired position; and
sending the desired position to the navigation device via the wireless communication means.

21. A method as claimed in claim 20 further comprising:
determining a travel direction of the portable computing device based upon sequential determinations of the absolute position of the portable computing device;
determining, via the further processing unit, a desired bearing as a relative bearing between the travel direction and a desired direction, the desired direction being that from the absolute position and the desired position;
sending the desired bearing to the navigation device via the wireless communication means;
determining, at the processing unit of the navigation device, a desired direction based upon the desired bearing and a reference direction of travel of the navigation device; and
indicating the desired direction on the display of the navigation device.

22-37. (canceled)
